(19) United States
(12) Patent Application Publication
(10) Pub. No.: US 2002/0022097 A1
(43) Pub. Date: Feb. 21, 2002

(54) Inflatable cellular cushioning material

(76) Inventor: Dennis Allen Cope SR., Crossville, TN (US)

Correspondence Address: BAKER & BOTTS, 30 ROCKEFELLER PLAZA, NEW YORK, NY, 10112

(21) Appl. No.: 09/863,481

(22) Filed: May 23, 2001

Related U.S. Application Data
(60) Provisional application No. 60/206,629, filed on May 24, 2000.

(51) Int. Cl. B32B 1/02

(52) U.S. Cl. 428/35.2

(57) ABSTRACT

A valveless selective cushioning container is provided having at least two inflatable cells, at least one of which has three layers, where the middle layer has an aperture preferably located at the crown of the cell such that after inflation the aperture may be heat sealed across the top layer to achieve selective cushioning.

### PRIOR TECHNOLOGY OR METHODOLOGY

The present invention relates to inflatable or fillable cellular containers which can hold fluid or gas. A wide variety of plastic fluid containers are known in the art and examples include the following U.S. Pat. Nos.: 4,850,912; 4,651,369; 4,076,872; 4,983,138; 5,248,275; 5,727,270; 6,015,047; 5,857,571; 5,862,914; 5,875,897; 5,901,850; 5,902,660; 5,911,657; 5,937,462; 5,942,076; 5,950,833; 5,952,065; 5,960,975; 5,967,390; 5,971,006; 5,996,798; 6,015,471. There are in existence, moreover, many inflatable cushions with valves to each compartment and/or having compartments with fluid communication.

### SUMMARY OF INVENTION

Unlike past valveless structures which used four layers and were self-sealing, or valved structures which were two layers, this invention provides for a valveless three layer selective cushioning container, which uses fewer raw material than current valveless containers and which is compartmentalized into shock absorbing sections that are selectively sealed and therefore selectively cushioned. Seals are preferably made at selected apertures at the crown of selected cells at full inflation. Those cells which are not selectively sealed allow for a shock absorbing action to take place, forcing fluid to adjacent cells. In operation, the aperture and fill channel act as a baffle as the cell slowly collapses. This baffling action allows for the communicating cells to equalize, thus allowing for the selective cushioning of the device.

In accordance with another embodiment of this invention, it is possible to save even greater material by eliminating the middle layer of most of the cells of any particular container. This can effectively be accomplished, provided there is communication by the two layered cells with at least one three-layered cell, as described below.

Thus, there is provided a valveless selective cushioning container, comprising at least two inflatable cells, at least one of which comprises a three layer structure having first, second and third layers each of a gas impervious flexible material, wherein the second layer has two ends and an aperture therebetween, and wherein the first and second layers are heat sealed together by an inlet seal on opposite sides of the aperture to form an inlet channel between the first and second layers and the inlet seal; and wherein the first, second, and third layers are sealed together by an outside seal at the layers periphery such that the outside seal defines boundaries of the structure; and wherein the cells communicate and are inflated with gas through the fill channel.

### BRIEF DESCRIPTION OF THE DRAWINGS

The foregoing brief description as well as further objects, features, and advantages of the present invention will be understood more completely from the following detailed description of the presently preferred, but nonetheless illustrative, embodiments of the invention, with reference being had to the accompanying drawings in which:

FIG. 1 is a cross-section view of a cell of the container of the present invention;

FIG. 2 is a cross-section view of a cell of the container of the present invention after inflation;

FIG. 3 is a cross-section view of the container of the present invention showing the inlet sealed at different locations.

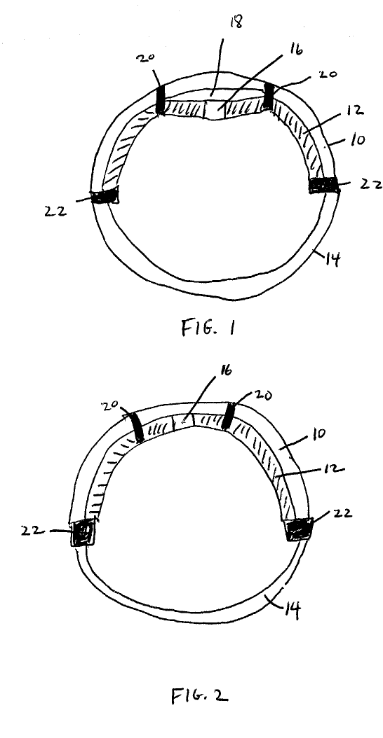

### DESCRIPTION OF THE INVENTION

The present invention relates to sealing inflatable containers which consist of one or more inflatable cells at least one of which has three layers, where the middle layer has an aperture located at the crown of the cell such that after inflation the aperture may be sealed by heat sealing across the top layer. More specifically, as shown in the accompanying drawings, the system comprises a three layer structure layers 10, 12 and 14. Layer 12, the middle layer, has an aperture 16 at its center. At first, to form an inlet channel 18 (for filling with air), layers 10 and 12 are sealed around aperture 16 of each cell. The channel is intended to receive air and hold the aperture 16 at the crown of the cell; thus, the channel is formed by heat seal 20 between layers 10 and 12. Each cell is defined by outside heat seal 22 which seals layer 14 to layers 10 and 12. Outer seal layer 22 is formed around inlet channel 18 such that the inlet channel and aperture 18 are spaced in from the seal 22 which is preferably located at the perimeter of each cell. A fill channel 24 (as seen in FIGS. 4 and 5) allows the filling of adjacent cells simultaneously. It acts like a manifold, allowing the filling of the sections. After the construction, the cells are subsequently filled preferably by the following process.

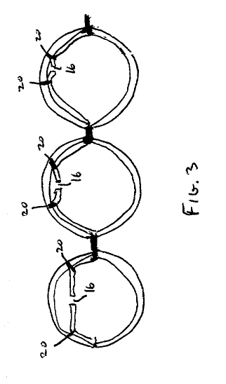

Gas or fluid is input through the fill channel 24, which then feeds through layers 10 and 12 (i.e., through inlet channel 18) and then through each aperture 16 to inflate each cell, between layers 12 and 14. As shown in FIG. 2, the aperture 16 is then raised to the crown of cell (layer 12 is pushed to the top of layer 10) and is then heat sealed so no gas or fluid can escape. Because there is no counterbalancing force or opposite seal, and because layer 12 preferably has more material than layer 10, there is a tendency for layer 12 to droop or act as a baffle, thus the heat seal is necessary.

Significantly, the invention provides that the cushioning of the structure can be selectively controlled by either (1) heat sealing selective cells (at each crown), thus allowing each heat sealed cell to remain filled and independent, or (2) not heat sealing and allowing certain cells or sections of cells to remain communicative with each other and consequently droop or deflate. Communication between cells can occur by the use of heatseal barrier. Further, as shown in FIG. 3, the closer the inlet seal to the aperture 16, the easier to seal and the fuller the bubble. Thus, the size of each cell and therefore the sections of cells can be controlled.

In addition, the present invention allows for the saving of even more material by using the three layer structure in only the first row of cells and two layers for the remaining cells. In this embodiment, the first row of cells would need a middle layer (with an aperture) to cover enough of the first layer to make an inlet channel for intake of fluid. The remaining cells of the structure could be two layered only—without a middle layer and without an inlet channel.

Although preferred embodiments of the invention have been disclosed for illustrative purposes, those skilled in the art will appreciate that many additions, modifications, and substitutions are possible without departing from the scope or spirit of the invention as defined in the accompanying claims.

I claim:

1. A valveless selective cushioning container, comprising:
at least two inflatable cells, at least one of which comprises a three layer structure having first, second and third layers each of a gas impervious flexible material, wherein said second layer has two ends and an aperture therebetween, and wherein said first and second layers are heat sealed together by an inlet seal on opposite sides of said aperture to form an inlet channel between said first and second layers and said inlet seal; and wherein said first, second, and third layers are sealed together by an outside seal at the layers periphery such that the outside seal defines boundaries of said structure; and wherein said cells communicate and are inflated with gas through said fill channel.

2. The container of claim 1 wherein each said three layered cell has a crown and said aperture is located equidistantly from said ends and upon inflation said aperture is raised to the crown of said cell, and said second layer is further heat sealed to said first layer at said crown to prevent the escape of gas, such that selective cushioning is achieved by selectively heat sealing one or more of said three-layered cells at said crown.

3. The container of claim 2 further comprising a manifold connecting the inlet channels of each said three layered cell.

4. The container of claim 3 wherein the size of each said three layered cell is dependent on the placement of said inlet seal.
